(19) United States
(12) Patent Application Publication
(10) Pub. No.: US 2024/0411280 A1
(43) Pub. Date: Dec. 12, 2024

(54) METHOD FOR OPERATING A PROCESS SYSTEM, PROCESS SYSTEM, AND METHOD FOR CONVERTING A PROCESS SYSTEM

(71) Applicant: Linde GmbH, Pullach (DE)

(72) Inventor: Nicolas BLUM, Pullach (DE)

(21) Appl. No.: 18/697,872

(22) PCT Filed: Sep. 13, 2022
(86) PCT No.: PCT/EP2022/025426

§ 371 Date: Apr. 2, 2024

(30) Foreign Application Priority Data
Oct. 7, 2021 (EP) 21020502.7

(51) Int. Cl. G05B 13/04; G05B 13/02

(52) U.S. Cl. CPC G05B 13/048; G05B 13/0265; G05B 13/041

(57) ABSTRACT

A method for operating a process system, in which method one or more actuators in the process system are set by means of one or more manipulated variable values, whereby one or more operating parameters of the process system are influenced. The setting of the one or more manipulated variable values is carried out at least in an operating phase using a self-optimizing control process, wherein the self-optimizing control process comprises the use of model-based reinforcement learning using Gaussian processes, and wherein one or more components of the process system are imaged in a model by means of one or more Gaussian processes, which model is used in the model-based reinforcement learning. The present invention also relates to a corresponding process system and to a method for converting a process system.

The invention relates to a method for operating a process system, in particular an air fractionation plant, a process system and a method for converting a process system according to the respective preambles of the independent claims.

### BACKGROUND OF THE INVENTION

The present invention is described below predominantly with reference to methods and systems for the cryogenic fractionation of air, which is why such methods and systems are to be discussed briefly here first. As also explained below, the present invention can, however, also be used in other process systems, in particular, but not exclusively, in systems in which cryogenic separation of component mixtures takes place, such as systems for processing natural gas or product mixtures and comprising syntheses or conversion processes such as reforming, cracking, etc. Such systems are also generally referred to as gas systems. In particular, in the context of the present application, process systems (also referred to as chemical systems) are understood to mean systems for carrying out process methods, i.e., substance changes and/or substance conversions and/or substance separations, which is done, for example, by means of targeted physical and/or chemical and/or biological and/or nuclear effects.

The production of air products in the liquid or gaseous state by cryogenic fractionation of air in air fractionation installations is known and described, for example, in H.-W. Häring (editor), Industrial Gases Processing, Wiley-VCH, 2006, in particular Section 2.2.5, “Cryogenic Rectification.” In the following, the term “air fractionation plant” refers here to a cryogenic air fractionation plant.

Air fractionation plants of the classic type have rectification column systems that can be designed as two-column systems, in particular as double-column systems, but also as triple-column or multi-column systems. In addition to rectification columns for obtaining nitrogen and/or oxygen in the liquid and/or gaseous state, i.e., rectification columns for nitrogen-oxygen separation, rectification columns for obtaining further air components, in particular of noble gases, can be provided.

The rectification columns of the mentioned rectification column systems are operated at different pressure levels. Known double-column systems have a so-called high-pressure column (pressure column, medium-pressure column, lower column) and a so-called low-pressure column (upper column). In these columns, the separation is maintained in particular by means of a feed of liquid reflux streams specified by means of control devices.

Air fractionation plants place high demands on higher-level process management as regards not only the system type but also the requirements relating to load-changing capabilities and yield optimizations. They are characterized by an intensive coupling of the rectification columns and other apparatuses via heat and mass balances and from a control technology perspective constitute a highly coupled multi-variable system. In addition, the setpoint values of the variables to be controlled (analyses, temperatures, etc.) are dependent on the load case. On the other hand, air fractionation plants for the production of gaseous products, for example, must quickly follow demand with production and at the same time ensure as high a product yield as possible (in particular of oxygen and/or argon). In this case, a so-called base controller can tune a process parameter to a setpoint value. Such a process parameter is formed by a physical variable which has an influence on the process of air fractionation, for example via the pressure, the temperature or the flow at a specific point in the air fractionation plant or in a specific method step.

In rather conventional air fractionation plants, the base controller can be designed in particular as a P controller (proportional controller), PI controller (proportional integrative controller), PD controller (proportional derivative controller) or PID controller (proportional integrative derivative controller). Alternatively, two or more controllers can be interconnected as cascade controllers and used as base controllers. The totality of the base controllers is implemented together with the necessary locks and logics to form a so-called management system.

A so-called ALC controller (automatic load change) operates a level higher and specifies setpoint values for one or more base controllers, preferably for the complete system, i.e., for all base controllers. Automatic switching between the different load cases of an air fractionation plant is thus possible. This technique is typically based on an interpolation between a plurality of load cases set and captured during trial operation. In order to start a new load case, the target setpoint values of the base controllers of the management system are pre-calculated and then approached with a synchronized ramp, i.e., adjusted within a specified period of time in small time increments.

The ALC controller thus provides the base controllers with a tested route to the load case to be achieved. This results in a very high adjustment speed. Closed-loop control takes place at most in base control, for example via cascade controllers. Specifically, so-called trim controllers are used in the management system, wherein a base controller setpoint value (mean value) calculated beforehand by the ALC controller is corrected by a cascade circuit. The setpoint value of the cascade controller can also be specified by the ALC controller.

So-called model-predictive controllers or MPC controllers constitute an alternative to ALC controllers. MPC controllers can be used, in particular, for controlling more difficult and coupled multi-variable control sections. They are therefore particularly suitable for use in air fractionation plants. The basis is a mathematical model which represents the time behavior of controlled variables (CV) in response to changes in manipulated variables (MV). The use of simple first-order linear models, in particular with dead time (in so-called linear MPC controllers, LMPC), is customary in control technology. Alternatively, more complicated, for example non-linear models (in so-called non-linear MPC controllers, NMPC), can also be used. The entire process is described by many such models in a matrix representation. A resulting overall process model is used for control by simulating the behavior of the system into the future and finally calculating the time profile of the manipulated variables in such a way that control deviations are minimized and constraints (limit variables, LV) are maintained. An MPC controller allows the cross-relationships to be taken into account and thus enables particularly stable operation.

In other words, the basic idea of the MPC controller is to predict the future behavior of the controlled system over a finite time horizon and to calculate an optimal control input which, while ensuring the fulfillment of given system constraints, minimizes a cost functionality defined a priori. More precisely, a control input is calculated in the MPC controller by solving at each sampling time an optimal control problem with finite time horizon in the open control loop. The first part of the resulting optimal input trajectory is then applied to the system until the next sampling time at which the horizon is then shifted, and the entire process is repeated again. Due in particular to its capability, the MPC is advantageous for explicitly incorporating hard state and input conditions as well as a suitable power criterion into the controller design.

MPC controllers can effectively control a cryogenic air fractionation plant in steady-state operating mode. Load change means for the MPC controller the specification of new target setpoint values for measurable production quantities, and on this basis the MPC controller tunes the entire process to the new load case. However, the course of the load change and its duration are not predictable, usually being significantly slower than in the case of an ALC controller, and often very unsteady. There basically is no mechanism to prespecify setpoint values in a load-dependent manner.

It has been found that conventional control methods in air fractionation plants and other processing system cannot always ensure optimal operation. The object of the present invention is, therefore, to improve the control of process technology systems, in particular air fractionation plants.

### DISCLOSURE OF THE INVENTION

This object is achieved by a method for operating a process system, in particular an air fractionation plant, a process system and a method for converting a process system having the respective features of the independent claims. Embodiments of the present invention are respectively the subject matter of the dependent claims and the following description.

### Advantages of the Invention

The present invention is based on the finding that a control concept based on model-based reformation learning using Gaussian processes is particularly suitable for controlling a process system, such as an air fractionation plant or another system in which substance changes and/or substance conversions and/or substance separations are carried out, wherein the model used images the system or at least a part of the system and is based on Gaussian processes, in particular multivariate Gaussian processes. In this context, the control system operates with self-optimization, i.e., it improves the control strategies used continuously and in particular on the basis of an evaluation of the results obtained with previously used control strategies and/or earlier parameters and variables used in the control system. This is achieved, for example, by updating a database for the Gaussian processes on which the n model is based, as described in detail further below.

Overall, the present invention proposes a method for operating a process system, in particular an air fractionation plant, in which one or more actuators in the process system are set by means of one or more manipulated variable values, whereby one or more operating parameters of the process system are influenced.

The actuators set within the scope of the present invention can be, in particular, valves or other fittings or groups of fittings used to influence the flow rate of one or more material flows. A corresponding actuator can for example be an actuating device for setting a compressor delivery rate or a turbine as well as a heating element or the like. In this case, the setting of corresponding actuators has a direct or indirect influence on parameters, measured values or actual values referred to here as operating parameters, for example a column pressure, a column temperature, a temperature profile in a column, a substance yield, a product purity, a composition of certain material flows and the like. By indicating that operating parameters of the process system are influenced is intended to mean a targeted change in corresponding operating parameters, for example a temperature, pressure or flow rate increase or reduction or a targeted effect on substance purity or mixture compositions, but also a targeted holding constant of such operating parameters, for example a temperature profile in a column.

The present invention preferably also makes use of a cost function, which is comprised by the self-optimizing process and, in the context of the present invention, is designed in particular in such a way that it takes into account consumption parameters such as energy consumption or the quantity of feed streams used, for example of feed air, and is assessed in relation to the respective target parameters, for example a product quantity or product purity. In particular in the context of the present invention when an air fractionation plant is used, a penalty for the amount of feed air used enters into the method with a weighting that is, in particular, variable. This has the consequence that a critical point of the control is the saving on the amount of feed air, which has particular effects on the energy requirement based on the compressor delivery rate to be applied. Furthermore, so-called soft constraints, in particular in the form a·exp(b·(x−c)^{d}), are integrated into the cost function. These relate to further operating parameters which, in fact, do also have an influence on the control, but to a lesser extent than the amount of feed air. In particular, no Lagrange multipliers are used, so that the disadvantage associated therewith—that non-linear equation systems are produced which are difficult to solve—is avoided. In particular, an insoluble optimization problem is prevented from arising.

According to the present invention, the one or more actuators are set at least in an operating phase (or process phase) by means of a self-optimizing control process, wherein the self-optimizing control process comprises the use of model-based reinforcement learning and preferably also the consideration of the already mentioned cost function. In this case, one or more components of the process system are imaged in a model by means of one or more Gaussian processes which is used in the model-based reinforcement learning.

As input values for the one or more Gaussian processes or the model formed therewith (which images system behavior) further process parameters in particular are used in addition to manipulated variables and controlled variables relating to the operating parameters. In the case of the historical manipulated and controlled variables, it should in particular be ensured that their values are similar to one another, i.e., lie within certain value ranges, for example, in order thus to limit the total amount of data to be taken into account. This allows for the best possible real-time control, as will be explained in more detail below.

In one embodiment of the invention which relates to an air fractionation plant, the controlled variables or operating parameters comprise one or more temperatures and one or more oxygen analyses, in particular two temperatures and three oxygen analyses, in the column system of the air fractionation plant. The manipulated variables are in particular one or more mass flows and one or more valve positions, in particular two material flows and one valve position in the example. In addition, however, the bottom levels and pressures of the double column used are also fed to the model. In this case, for example, a prespecified number of minutes is considered for each process value. For a prespecified number of sampling values of a process parameter per minute, this results in the number of inputs multiplied by the number of minutes in order to represent the current state of the system.

In addition to the state, another proposal for the future trajectory of the manipulated variables is also transferred to the model. In the aforementioned example, it is three manipulated variables, so that—again for a period comprising a fixed number of minutes—at a fixed number of sampling values per minute, the number of inputs multiplied by the number of minutes results.

In the present invention, the future behavior of the controlled system, i.e., the process system, over a specified time horizon is thus predicted by means of the model. In this way, an optimal control input can be calculated better than in model-predictive control and, while ensuring compliance with given system constraints, in particular also minimizes the defined cost functionality. However, as is basically also described for the MPC, the first part of the resulting optimal input trajectory until the next sampling time, i.e., the process system to which the horizon is then shifted, can be applied to the system, and the entire method is repeated again. The use of a model based on Gaussian processes in this case is better able to find an optimal control strategy in a self-optimizing manner as compared with the approaches known from the MPC. In particular, the use of Gaussian processes allows for rapid convergence and continuous online or real-time learning. In addition to the future behavior being predicted, any uncertainties occurring in the process (i.e., possible deviations of the predicted values of the individual parameters) are also obtained, which is a special feature of the Gaussian processes. These uncertainties in turn allow the robustness of the entire control system to be improved. The uncertainties can thus be taken into account in the self-optimizing control process during optimization.

In probability theory, a Gaussian process is generally a stochastic process in which each finite subset of random variables has a multidimensional normal distribution (Gaussian distribution). In general, a Gaussian process represents temporal, spatial, or any other function whose function values can only be modeled with certain uncertainties and probabilities due to incomplete information. It is constructed from functions of the expected values, variances, and covariances and thus describes the functional values as a continuum of correlated random variables in the form of an infinite-dimensional normal distribution. A Gaussian process is thus a probability distribution of functions. A sample therefrom results in a random function with certain preferred properties.

Gaussian processes are used, for example, to mathematically model the behavior of non-deterministic systems based on observations. Exactly this is done here for a process system as such a system with, for example, historical data as the observations. As shown, this allows for a particularly efficient and sufficiently accurate modeling of the system or of components thereof which is required in the context of control. In particular, this takes advantage of the fact that Gaussian processes are very well suited for interpolation, extrapolation, or smoothing of arbitrary dimensional discrete measurement points (Gaussian process regression or Kriging process). In the case of Gaussian processes, the extrapolation behavior, for example, in contrast to (artificial) neural networks, is deterministic and/or can be influenced in a targeted manner. In this case, Gaussian processes can be used like a supervised machine learning method (i.e., the reinforcement learning mentioned above) for abstract modeling, for example, using training examples, wherein no iterative training is necessary as in neural networks. Instead, Gaussian processes are derived very efficiently from statistical variables of the examples with linear algebra and can be clearly interpreted mathematically and well controlled. In addition, for each individual output value, an associated confidence interval—the mentioned uncertainty of the behavior—is computed which accurately estimates the own prediction error, while known errors in the input values are correctly incorporated. Compared to models based on neural networks, model based on Gaussian processes are not so-called black boxes, but rather allow for accurate traceability.

In this context, it should also be mentioned that the term “process” is usually associated with a time process; however, a Gaussian process or stochastic process is in particular only the mathematical description of an uncertainty of any continuous functions. Rather, a Gaussian process is to be understood as a probability distribution.

The outputs of the model correspond, in other words, to a prediction of how the controlled variables or operating parameters will change. In the case of the five controlled variables in the example, for a period expressed in a number of minutes the number of values multiplied by the number of minutes with a fixed number of values per minute is again obtained as number of outputs.

In addition, compared to a one-step-ahead prediction model (i.e., with a pure feed-forward structure), the advantage is that the model is modeled such that not only the first prediction step is well adapted, but a compromise is reached for all prediction steps. This also improves the prediction quality for the later steps.

Due to the very extensive data history, it is advantageously provided in one embodiment of the present invention to carry out a relevance check of data points that can be used for modeling the model. For this purpose, a relevance assessment of the data points, for example comprising a 2D clustering of the data and an evaluation providing relevance assessment, such as a principal component analysis, can be carried out. Training data are then “drawn” from the clusters, i.e., training data of sufficient relevance are determined, until a certain size of the data set is reached.

The present invention with the proposed method relates to the field of machine learning. In machine learning, algorithms and statistical models are used by means of which systems, in the present case a control device, can carry out a particular task, here a control task, without explicit instructions and, instead, rely on the models used and conclusions derived therefrom. For example, in a control device that is used for machine learning, instead of a rule strategy based on certain rules, a control strategy can be used that is derived from an analysis of historical data and/or training data, wherein the analysis is performed with utilization of the model used and can thereby undergo a flexible adaptation which is used for an optimization.

By training or modeling the model used during machine learning with a large amount of training data and associated information about the content of the training, the model behaves (increasingly) at least approximately like the modeled real system, so that actions based on the model and recognized as advantageous, in the present case control strategies, can be used for the real system.

As is generally known and not explained in more detail here, machine learning can take place in the form of so-called supervised learning, so-called partially supervised learning or in the form of unsupervised learning. These terms refer in particular to the way in which the model is trained. For further details in this connection, refer to relevant technical literature.

Reinforcement learning involves a further group of machine-learning algorithms. In reinforcement learning, one or more so-called agents are trained therein to carry out certain actions in a defined environment. Based on the actions performed, a reward is calculated, which may even turn out to be negative. In reinforcement learning, the agents are trained to select a plurality of actions in coordination with one another in such a way that the cumulative reward from the actions overall is increased, which leads to the software agents better fulfilling the task given to them. The reward in model-free reinforcement learning corresponds to the aforementioned cost function in the present invention.

The basic idea of the present invention is based on the combination of reinforcement learning with a model which images the system operated according to the invention and, as mentioned, is based on Gaussian processes. Advantageous aspects of the invention comprise, in particular as also explained below: the basic modeling or adjustment of the Gaussian processes used in the model, that the model is retrained or its training is continued (or adapted or adjusted) in the course of the system operation, so that a continuous improvement of the control is achieved, the specific type of generation of the training data and the selection thereof for the training process, and the continuous checking of the model and control quality during operation with automatic reversion to a basic control in the event of insufficient quality. In contrast to, for example, (artificial) neural networks, Gaussian processes do not require the parameters in the model to be continuously adapted by a training process. Rather, the database is continuously expanded with new process data, and the model based on Gaussian processes (Gaussian process model) uses this data as a reference in each prediction.

As shown, these advantages surprisingly also apply to the aforementioned process systems in which substance changes and/or substance conversions and/or substance separations are carried out, i.e., continuous processes or operations, not only discrete processes or operations.

By means of the present invention, a significantly better controller adaptation and an overall better energy efficiency can be achieved in particular in the event of load changes. The invention uses, in particular, the aforementioned cost function, which are advantageously defined on the basis of product criteria (purity, composition, quantity) or consumption criteria (energy, starting materials) of the process system, as mentioned above. This is not the case, for example, in the MPC controller conventionally used in corresponding systems.

The present invention may comprise, in particular, operating the process system first manually and/or by means of a different control process, for example using a cascade controller or a linear or other MPC controller, and modeling or training the self-optimizing control process provided according to the invention or the model used therein that uses Gaussian processes to image the system using training data obtained in this way. In this way, i.e., by training with historical data or data obtained by means of a different control process, this model can be capable of predicting specific operating parameters of the system for certain manipulated variable values. A model which is based on Gaussian processes or implemented using the neural network and is set accordingly can in this way then be used in the context of the present invention together with the cost function, in the context of the control device provided according to the invention. The training data can in particular be the one or more aforementioned system parameters which are influenced by the setting of the one or more manipulated variable values, as also mentioned.

In other words, the proposed method advantageously comprises the fact that the setting of the one or more manipulated variable values in a second operating phase is carried out using the self-optimizing control process, that the system is operated manually and/or using a further control process, in particular a non-self-optimized control process, in a first operating phase, which comes before the second operating phase, and that the model (used in the self-optimizing control process) or the Gaussian processes are first used by means of training data obtained in the first operating phase, i.e., the system is operated with the model using the training data obtained in the first operating phase.

After this, the model can be used or adjusted by training data obtained in the second operating phase, i.e., with training data which result from the use of the self-optimizing control process, in which process the previously created model is already used. As a result, as will also be explained in more detail below, a continuous improvement in controller behavior can be achieved. In general, however, as mentioned, iterative training, i.e., adjusting model parameters or model weights, is not necessary in the case of Gaussian processes.

In a first cycle of the second operating phase, in which the model is still present as modeled exclusively with the training data obtained in the first operating phase, the model, due to the limited extrapolation behavior, will typically also use only similar control strategies as have been previously used, and accordingly it is to be expected that the control quality will also be similar. As soon as training data are now available from the second operating phase, i.e. the self-optimizing control process is used, the newly obtained training data can be added to the training data available to date in a corresponding data set of training data. After this, the model is modeled again with the previously determined and newly determined training data and is integrated into the control process. Even if the control strategies are still similar to the previous ones, over time an ever more improved control strategy is found via the constant repetition of corresponding model updates and via the slight discrepancy in relation to past strategies.

Ultimately, the model, together with the cost function, represents a scalar field in hyperdimensional space in which a minimum can be sought by an optimizer in the control process used. However, the scalar field is valid only in such ranges where training data were previously present. In this context a local minimum, for example, is found in surrounding regions. Depending on which evaluation (positive or negative) results in a newly trained model for corresponding ranges, the control process will be more strongly oriented, or not, in a corresponding direction.

In the method proposed according to the invention, one or more actual values of the one or more operating parameters are advantageously acquired for one or more past instants. Using the one or more actual values acquired in this way, one or more prediction values for the one or more operating parameters are advantageously determined for one or more future instants, and the one or more manipulated variable values are advantageously specified by means of the model using one or more setpoint values for the one or more operating parameters and using the one or more prediction values. The use of the proposed method results in a subsequent improvement in the control, in particular an improvement in the reliability of the prediction values, on the basis of which the respective setting values are determined.

Overall, new control strategies can be explored in the context of the present invention by means of the model or Gaussian process in repeated exploration loops. As has been mentioned, training values are advantageously used which originate from an initial operation of the process system carried out by means of another control method or manually and which are subsequently replaced by later values, which are obtained using the self-optimizing control process itself, which process leads to an increasing optimization of the control.

As mentioned, the one or more actuators may, in particular, be or comprise one or more valves, the one or more manipulated variable values may be or comprise manipulated variable values of the one or more valves, and the one or more operating parameters may be or comprise one or more mass flows or temperatures. This applies in particular in the case that the proposed method is used in an air fractionation plant. In a specific example, a return valve, an amount of feed air and an argon conversion are set.

In a particularly preferred embodiment of the method according to the invention, the one or more manipulated variable values are assessed for their suitability prior to their use for setting the one or more actuators. This may comprise, in particular, a plausibility check or a comparison with past values in order to eliminate implausible or unsuitable values.

The one or more prediction values for the one or more operating parameters for the one or more future instants can also be compared, in one embodiment of the present invention, to real values later obtained at these instants, a prediction quality being determined on the basis of the comparison. This can be used, in particular, for continuous monitoring of the prediction quality in order to be able to initiate measures in the event of a deterioration beyond a permissible degree.

In particular, in other words, an adaptation of the self-optimizing control process can be undertaken or the self-optimizing control process can be replaced by a different control process if the determined prediction quality falls below a specified minimum quality. For example, in this case, a fallback control process (which may be poorer in terms of energy or with respect to the yield or the cost function) can be used and, starting therefrom, in particular a new optimization can be initiated in the manner explained. Optionally, it is also possible to use a previously used optimization state, which can be temporarily stored for this purpose. A corresponding quality assessment can also include identifying certain past values as advantageous training data, as already mentioned.

In the context of the present invention, the self-optimizing control process can also be used in combination with an ALC controller in the manner already described in the introduction.

The invention also relates to a process system, in particular an air fractionation plant, which is configured to set one or more actuators in the process system using one or more manipulated variable values and thereby influence one or more operating parameters of the process system.

According to the invention, the system is characterized in that a control device is provided which is configured to carry out the setting of the one or more manipulated variable values at least in an operating phase by means of a self-optimizing control process and to carry out the self-optimizing control process using model-based reinforcement learning using Gaussian processes and in particular also considering a cost function, wherein one or more components of the process system are imaged in a model by means of one or more Gaussian processes, which model is used in the model-based reinforcement learning.

A method for converting a process system, which is configured to set one or more actuators in the process system using one or more manipulated variable values and thereby to influence one or more operating parameters of the system, is also the subject matter of the present invention.

According to the invention, this method is characterized in that, during the conversion of the system, an existing control process by means of which the one or more manipulated variable values are set is replaced by a self-optimizing control process, wherein the self-optimizing control process comprises the use of model-based reinforcement learning and in particular also the consideration of a cost function, and wherein one or more components of the process system are imaged in a model by means of one or more Gaussian processes which is used in the model-based reinforcement learning. The replacement of the existing control process with the self-optimizing control process comprises transferring control functions of the existing control process subsequent to the self-optimizing control process. In other words, control functions of the existing control process are therefore increasingly no longer carried out by means of the existing control process, in particular in succession or in groups, but instead by means of the self-optimizing control process.

With regard to further features of the process system provided according to the invention or to the process system converted by the method for conversion and further embodiments thereof, reference is expressly made to the above explanations relating to the method according to the invention and the embodiments thereof. A corresponding system is in particular configured to carry out a method as previously explained in different embodiments.

Further aspects of the present invention will be explained with reference to the accompanying drawings.

### BRIEF DESCRIPTION OF THE DRAWINGS

FIG. 1 illustrates an air fractionation plant which can be operated according to an embodiment of the present invention.

FIG. 2 schematically illustrates a sequence of a method according to an embodiment of the present invention.

FIG. 3 schematically illustrates aspects of a method according to an embodiment of the present invention.

FIG. 4 illustrates consumption histograms according to one embodiment of the invention and according to a non-inventive embodiment.

### DETAILED DESCRIPTION OF THE DRAWINGS

In the figures, elements that correspond to one another structurally or functionally are denoted by identical reference signs and, for the sake of clarity, are not repeatedly explained. When reference is made below to method steps, the corresponding explanations relate in the same way to system components with which these method steps are carried out, and vice versa.

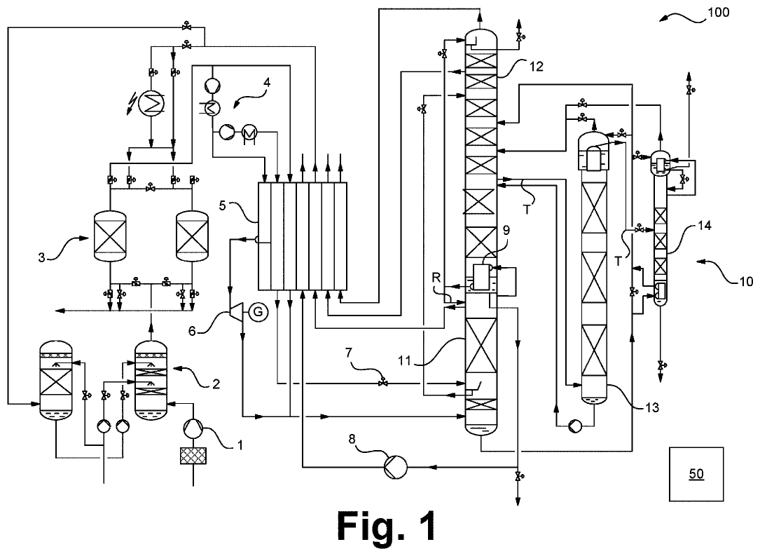

FIG. 1 shows an example of an air fractionation plant 100 of a known type which can be operated in particular by using a schematically illustrated control device 50, according to an embodiment of the present invention. As mentioned several times above, the present invention is also suitable for operating other process systems, in particular those in which substance changes and/or substance conversions and/or substance separations are carried out, and is not limited to air fractionation plants.

Air fractionation systems of the type shown are often described elsewhere, for example in H.-W. Häring (ed.), Industrial Gases Processing, Wiley-VCH, 2006, in particular section 2.2.5, “Cryogenic Rectification.” For detailed explanations regarding structure and operating principle, reference is therefore made to corresponding technical literature. An air fractionation plant for use of the present invention can be designed in a wide variety of ways.

The air fractionation plant shown in FIG. 1 has, among other things, a main air compressor 1, a pre-cooling device 2, a cleaning system 3, a secondary compressor assembly 4, a main heat exchanger 5, an expansion turbine 6, a throttling device 7, a pump 8 and a rectification column system 10. The rectification column system 10 comprises a double-column assembly made up of a high-pressure column 11 and a low-pressure column 12 and a raw argon column 13 and a pure argon column 14. The control proposed according to one embodiment of the invention can influence, for example, a reflux ratio, the amount of feed air and the argon conversion; further variables can be operating parameters of an expansion machine and level states in the columns or in a part of the columns.

As the invention is not limited to the use with air fractionation plants, such as the air fractionation plant 100, it can also be used with air fractionation plants designed differently than shown, which can have a lower or greater number of rectification columns in an identical or different connection to one another.

In the air fractionation plant 100 shown, an input air flow is sucked in and compressed by means of the main air compressor 1 via a filter (not labeled). The compressed input air flow is supplied to the pre-cooling device 2 that is operated with cooling water. The pre-cooled input air flow is cleaned in the cleaning system 3. In the cleaning system 3, which typically comprises a pair of adsorber vessels used in alternating operation, the pre-cooled input air flow is largely freed of water and carbon dioxide.

Downstream of the cleaning system 3, the input air flow is divided into two subflows. One of the subflows is completely cooled at the pressure level of the input air flow in the main heat exchanger 5. The other subflow is recompressed in the secondary compressor assembly 4 and likewise cooled in the main heat exchanger 5, but only to an intermediate temperature level. After cooling to the intermediate temperature, this so-called turbine flow is expanded by means of the expansion turbine 6 to the pressure level of the completely cooled subflow, combined with it, and fed into the high-pressure column 11.

An oxygen-enriched liquid bottom fraction and a nitrogen-enriched gaseous top fraction are formed in the high-pressure column 11. The oxygen-enriched liquid bottom fraction is removed from the high-pressure column 11, partially used as heating medium in a bottom evaporator of the pure argon column 14, and fed in each case in portions into a top condenser of the pure argon column 14, a top condenser of the raw argon column 13, and the low-pressure column 12. Fluid evaporating in the evaporation chambers of the top condensers of the raw argon column 13 and the pure argon column 14 is also transferred into the low-pressure column 12.

The gaseous nitrogen-rich top product is removed from the top of the high-pressure column 11, liquefied in a main condenser which produces a heat-exchanging connection between the high-pressure column 11 and the low-pressure column 12, and, in proportions, applied as a reflux to the high-pressure column 11 and expanded into the low-pressure column 12.

An oxygen-rich liquid bottom fraction and a nitrogen-rich gaseous top fraction are formed in the low-pressure column 12. The former is partially brought to pressure in liquid form in the pump 8, heated in the main heat exchanger 5, and provided as a product. A liquid nitrogen-rich flow is withdrawn from a liquid retaining device at the top of the low-pressure column 12 and discharged from the air fractionation plant 100 as a liquid nitrogen product. A gaseous nitrogen-rich flow withdrawn from the top of the low-pressure column 12 is conducted through the main heat exchanger 5 and provided as a nitrogen product at the pressure of the low-pressure column 12. Furthermore, a flow is removed from an upper region of the low-pressure column 12 and, after heating in the main heat exchanger 5, is used as so-called impure nitrogen in the pre-cooling device 2 or, after heating by means of an electric heater, is used in the cleaning system 3.

Conventional air fractionation plants of the type illustrated can be controlled in particular by means of cascade controllers or (linear) MPCs. The control objective is, for example, to set a specific temperature profile in the high-pressure column 11. Here the control device 50 can control, for example, a return flow R of the top gas condensed in a main condenser 9 to the high-pressure column 11. For example, one or more temperatures in the high-pressure column 11, which are detected by means of corresponding temperature sensors, serve as controlled variables. A corresponding control typically also acts on a plurality of further actuators to achieve further control objectives.

If a method according to one embodiment of the invention is to be used here, a self-optimizing control process explained in detail above can be implemented in the control device 50. In a first step, the control of the temperature profile in the high-pressure column 11 can be undertaken by the self-optimizing control process, which now monitors via the return valve for the return line R. In particular, it can be determined here that the control quality is significantly improved during load changes. In such a load change scenario, a root mean square error (RMSE) for the temperature in the pressure column in a control system according to an embodiment of the invention has, as shown, a significantly lower value than, for example, an LMPC.

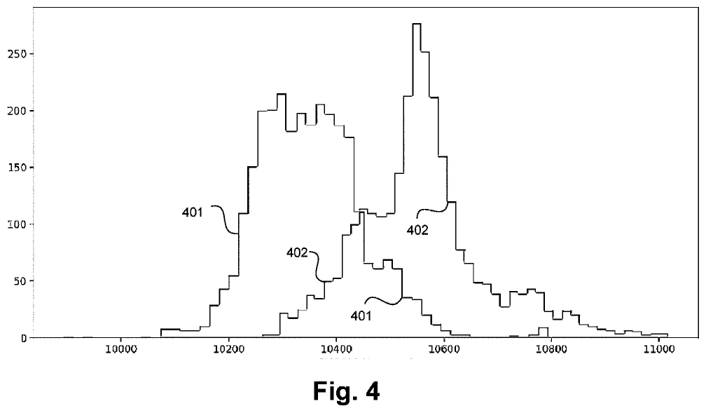

In the next step, all (in one example, three) main control loops (in the example, relating to a return quantity, the amount of feed air and an argon conversion) can be transferred to the self-optimizing control process, and the control process previously used for this purpose can be deactivated. The entire air fractionation plant 100 can then still be operated only via simple cascade controllers and the self-optimizing control process. In this case a reduction in the amount of air used can be determined, for example, as around 2%, as illustrated in FIG. 4. The temperature profile in the high-pressure column 11 and the low-pressure column 12 and the composition of a transfer stream T transferred from the low-pressure column 11 into the raw argon column 13 can be used as (main) process variables and can be determined with corresponding sensors. The amount of air used, the return valve controlling the reflux R to the high-pressure column and the argon conversion (corresponding to a flow rate of the material flow T) can serve as manipulated variables. This results in a 5×3 control problem. The self-optimizing control process can operate with further process variables as input, for example the pure argon conversion (corresponding to a material flow P from the top of the raw argon column 13 into the pure argon column 14), a liquid oxygen purge signal (in order for no hydrocarbons to accumulate to form in the bottom of the low-pressure column 12, said column must be regularly purged, for example via the internal compression pump 8) and others. In addition to the stabilization of the three main process variables, the product purity of gaseous oxygen and nitrogen can also be stabilized by means of the self-optimizing control process. The values from the self-optimizing control process can still be checked for plausibility. In order to load the self-optimizing control process only with the main control circuits, other control loops can be co-currently run via linear equations, such as for example for setting the liquid levels in the rectification columns 11 to 14.

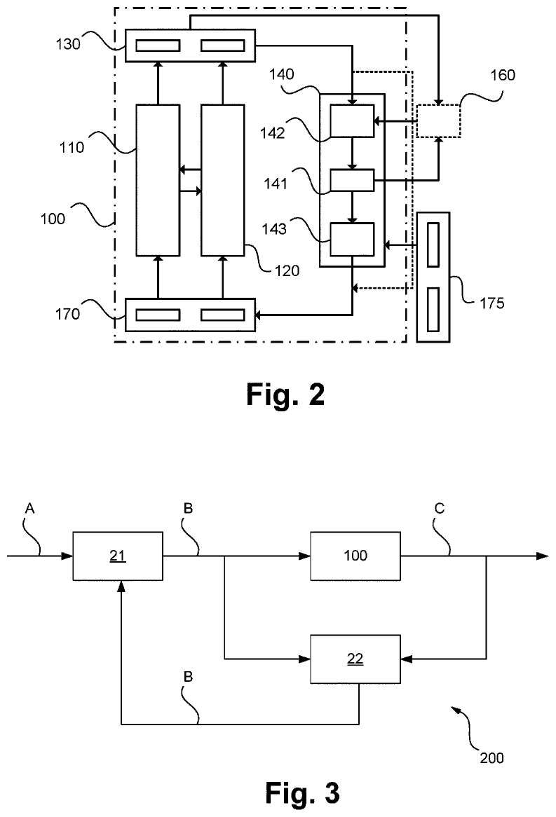

FIG. 2 schematically shows a sequence of a method according to the invention in a preferred embodiment that illustrates the control technology of the air fractionation plant 100. For this purpose, two processes 110, 120 taking place or running there are shown for the air fractionation plant 100. Such processes can be defined or prespecified by various parameters and, in particular, also be subject to a certain interaction.

During these processes 110, 120, and thus during operation of the air fractionation plant 100, various actions are carried out and different variables can be measured to obtain corresponding data 130. For example, a process can comprise a certain gas flow which reaches or is intended to reach a certain mass flow (as a manipulated variable) as a function of a valve position (as a controlled variable), as explained in the example of FIG. 1.

As already mentioned, the proposed method can be used for practically any industrial plant (air fractionation plants, petrochemical plants, natural gas plants and the like). In this case, complex subsystems which are difficult to manage with classic control methods, for example the control of a multi-phase line, a distillation column or the like, are advantageously considered as the processes to be controlled. Even small subsystems can sometimes be very difficult to control with classic methods, if, for example, not only the current measured variables (pressure, fill level, etc.) influence the control strategy, but also the history of these measured variables should or must be considered (because, for example, dead times are present in the system). However, corresponding systems can be imaged well with a model based on Gaussian processes.

Because such processes are typically controlled and thus a corresponding control loop is present, actual values of corresponding controlled variables are also acquired here. In the context of the data 130 obtained, these actual values are then fed to a model-predictive control or a model-predictive controller 140, which is implemented, for example, on a suitable computing unit such as the control device 50 previously illustrated.

The model-predictive controller 140 now includes a model 142 of the process system that represents at least the relevant processes 110, 120 which are to be controlled, or the corresponding parameters. The model 142 is imaged or depicted by means of Gaussian processes. Non-linear model-predictive control is thus achieved (NMPC).

On the basis of the actual values and/or further data about the processes, predictions about a future course or a future behavior of these data can now be obtained in the context of model-predictive control. Within the scope of an optimization, manipulated variables for the control circuits or processes are sought by means of which specified setpoint values 175, which are used in 143, for example, can be achieved by the controlled variables well and also simultaneously, from outside or from a user or according to a specified schedule or the like.

Values 170 of the manipulated variables found here are still checked for plausibility by an additional advanced process control system (APCS) and subsequently fed to the relevant processes 110, 120, or the manipulated variables are set there. The APCS controls additionally low-priority control loops via simple feed-forward and cascade controllers in order to limit the required computing capacity of the model-predictive controller and its model complexity.

In control theory, an APCS generally refers to a variety of techniques used in industrial process control systems. It can generally be used as an option and alternative to the basic process controllers. Basic process controllers are developed and constructed together with the process itself in order to meet basic operating, control, and automation requirements. An ACPS is generally added later, often over many years, to take advantage of certain performance or economic improvements in the process. However, as mentioned, the required computational capacity of the model-predictive controller and its model complexity can be limited, i.e., kept lower, by using it from the beginning.

In addition, the quality of the predictions in a past period in which the real values are already present is compared and checked, as illustrated by 141. If it is determined within the scope of the check 141 of the forecast quality that the prediction quality is outside the specified range and thus does not have sufficient quality, it is possible to switch to the base control of the system 100 in order to ensure safe operation. This is indicated by a dashed arrow. It is also particularly ensured during optimization in one embodiment of the invention that the proposals of the optimizer for the manipulated variables are in a range valid for the model based on Gaussian processes. The training or modeling of the model is to be illustrated by 160.

The model or the Gaussian processes themselves are updated or adjusted at regular intervals, for example daily, with the newly acquired historical data. In this case, the model regularly receives feedback as to how well the actually applied manipulated variable trajectories have contributed to solving the control problem. The controller can thus further improve without external assistance from, for example, operators or control engineers. During this update, the operation of the process system is carried out with the model that has just been used.

This training or modeling is carried out in particular also on the basis of the data 130 obtained in processes 110, 120 or generally during operation of the process system. Because over time the data set contains more and more data from the operation using the model 142 imaged by means of Gaussian processes, it is becoming increasingly easier to learn a high-quality representation of the system behavior.

FIG. 3 schematically illustrates aspects of a method according to an embodiment of the present invention, details of a control process being shown and denoted as a whole by 200.

The control process 200 acts on a system or a method, for example the previously illustrated air fractionation plant 100. An optimization step 21 and a prediction step 22 are part of the control process 200. A desired system parameter, for example a column temperature, is supplied to the optimization step 21 as illustrated by an arrow A. The optimization step 21 calculates therefrom a control value B for a flow rate for an instantaneous cycle, which is used in the method, for example of the air fractionation plant 100. Actual values C obtained can be supplied to the prediction step 22, for example for 20 past cycles, which step carries out a temperature prediction D for future temperatures on this basis and on the basis of the control value B. This is used in the optimization step 21. In the embodiment illustrated here, the prediction step 22 operates by means of a model based on Gaussian processes.

In other words, actuators, for example valves, are set in the process system 100 using one or more control values B, whereby one or more operating parameters of the process system 100 are influenced. This is done using the self-optimizing control process 200 illustrated herein, wherein the self-optimizing control process comprises the use of model-based reinforcement learning using Gaussian processes and in particular also the consideration of a cost function in 143. One or more components of the process system 100 are imaged in a model by means of one or more Gaussian processes which is used in the prediction step 22 and thus in the model-based reinforcement learning in the control process 200.

One or more actual values C of the one or more operating parameters are captured for one or more past times, as illustrated in FIG. 3, and one or more prediction values D for the one or more operating parameters are determined for one or more future instants using the one or more actual values C by means of the self-optimizing control process. The one or more manipulated variable values B are prespecified using one or more setpoint values A for the one or more operating parameters and using the one or more prediction values B by means of the self-optimizing control process.

FIG. 4 shows consumption histograms according to one embodiment of the invention and according to a non-inventive embodiment. These each provide the consumption of feed air for different operating states of an air fractionation plant, wherein an amount of feed air is illustrated on the horizontal axis and a number of corresponding sampling values corresponding to different operating instants is illustrated in arbitrary units and on the vertical axis. 401 shows a consumption histogram obtained according to an embodiment of the invention, 402 shows a consumption histogram obtained according to a non-inventive embodiment. As can be seen from this, the consumption of feed air when the method provided according to the invention is used is lower in the majority of cases than the embodiment not according to the invention.

1. A method for operating a process system, in which method substance changes and/or substance conversions and/or substance separations are carried out, wherein one or more actuators in the process system are set by means of one or more manipulated variable values, whereby one or more operating parameters of the process system are influenced, wherein the setting of the one or more manipulated variable values is carried out at least in an operating phase by means of a self-optimizing control process, wherein the self-optimizing control process comprises the use of model-based reinforcement learning using Gaussian processes, and wherein one or more components of the process system are imaged in a model by means of one or more Gaussian processes, which model is used in the model-based reinforcement learning.

2. The method according to claim 1, wherein a future behavior of the process system is predicted over a specified time horizon by means of the model, in particular in the context of controlling the one or more operating parameters of the process system.

3. The method according to claim 1, in which method the setting of the one or more manipulated variable values is carried out in a second operating phase by means of the self-optimizing control process, wherein the system is operated in a first operating phase, which precedes the second operating phase, manually and/or by means of a further control process, and wherein the model is first used by means of training data obtained in the first operating phase.

4. The method according to claim 2, in which method the model is subsequently used by means of training data obtained in the second operating phase, and/or in which the training data in each case comprise operating parameters assigned to specific manipulated variable values.

5. The method according to claim 1, in which method one or more actual values of the one or more operating parameters are acquired for one or more past instants at which one or more prediction values for the one or more operating parameters are determined for one or more future instants using the one or more actual values by means of the self-optimizing control process, and in which the one or more manipulated variable values are specified by means of one or more setpoint values for the one or more operating parameters and by means of the one or more prediction values by means of the self-optimizing control process.

6. The method according to claim 1, in which method new control strategies are explored by means of the model in repeated exploration loops.

7. The method according to claim 1, in which method the one or more actuators are or comprise one or more mass flows and/or valves, the one or more manipulated variable values are or comprise manipulated variable values of the one or more mass flows and/or valves, and the one or more operating parameters are or comprise one or more mass flows and/or substance concentrations and/or temperatures.

8. The method according to claim 1, in which method the one or more manipulated variable values are assessed for their suitability, in particular checked for their plausibility, prior to their use to set the one or more actuators.

9. The method according to claim 1, in which method the one or more prediction values for the one or more operating parameters for the one or more future instants are compared to real values later obtained at these instants, wherein a prediction quality is determined on the basis of the comparison.

10. The method according to claim 7, in which method an adaptation of the self-optimizing control process is performed or the self-optimizing control process is replaced by a different control process if the determined prediction quality falls below a specified minimum quality.

11. The method according to claim 1, wherein the self-optimizing control process also comprises considering a cost function.

12. The method according to claim 1, in which method a process system is operated in which a cryogenic separation of component mixtures takes place, wherein in particular an air fractionation plant is operated as the process system.

13. A process system configured to carry out substance changes and/or substance conversions and/or substance separations, and to set, by means of the manipulated variable values, one or more actuators in the process system and thereby influence one or more operating parameters of the process system, wherein a control device is provided which is configured to carry out the setting of the one or more manipulated variable values, at least in an operating phase, by means of a self-optimizing control process and to carry out the self-optimizing control process by means of model-based reinforcement learning using Gaussian processes, wherein one or more components of the process system is imaged in a model by means of one or more Gaussian processes, which model is used in the model-based reinforcement learning.

14. The system according to claim 13, which is designed in such a way that a cryogenic separation of component mixtures is carried out therein, and is designed in particular as an air fractionation plant.

15. A method for converting a process system), in which system substance changes and/or substance conversions and/or substance separations are carried out, and which system is configured to set one or more actuators in the process system by means of one or more manipulated variable values and thereby influence one or more operating parameters of the system, wherein in the conversion of the system, an existing control process, by means of which the one or more control values are set, is replaced by a self-optimizing control process, the self-optimizing control process comprising the use of model-based reinforcement learning using Gaussian processes, and wherein one or more components of the process system is imaged in a model by means of one or more Gaussian processes, which model is used in the model-based reinforcement learning, and in that the replacement of the existing control process with the self-optimizing control process comprises subsequently transferring control functions of the existing control process to the self-optimizing control process.
